(19) United States
(12) Patent Application Publication
(10) Pub. No.: US 2016/0181869 A1
(43) Pub. Date: Jun. 23, 2016

(54) INSULATION MONITORING SYSTEM FOR SERIES-COMPENSATED WINDINGS OF A CONTACTLESS ENERGY TRANSMISSION SYSTEM

(71) Applicant: Paul Vahle GmbH & Co. KG, Kamen (DE)

(72) Inventor: Faical TURKI, Bergkamen (DE)

(73) Assignee: Paul Vahle GmbH & Co. KG, Kamen (DE)

(21) Appl. No.: 14/760,281

(22) PCT Filed: Sep. 2, 2014
(86) PCT No.: PCT/EP2014/068578

§ 371 Date: Jul. 10, 2015

(30) Foreign Application Priority Data
Sep. 13, 2013 (DE) 10 2013 110 109.7

(51) Int. Cl. H02J 50/10; H02J 50/80

(52) U.S. Cl. CPC H02J 50/10; H02J 50/80

(57) ABSTRACT

A device for contactless energy transmission may include series resonant circuits on primary and secondary winding sides, which may each include at least one coil and at least two capacitors. The series resonant circuit on the primary winding side may be connected to an upstream circuit, and the series resonant circuit on the secondary side may be connected to a downstream circuit. One or both coils may be coupled to fault-recognition resistors.

The present invention relates to a device for contactless energy transmission, wherein the device features series resonant circuits on the primary and secondary sides which each feature at least one coil and at least two capacitors, and the series resonant circuit on the primary winding side is connected to an upstream circuit and the series resonant circuit on the secondary winding side is connected to a downstream circuit.

In contactless energy transmission systems, it is often preferred or required to monitor the insulation between the windings of the coils and the ferrite or the mounting plate of the inductive components in the magnetic transmission circuit. In on-grid operated systems, it is sufficient to detect a ground contact via a residual current circuit breaker. In insulated structures, as is the case with electric vehicles, an insulation monitoring device is used.

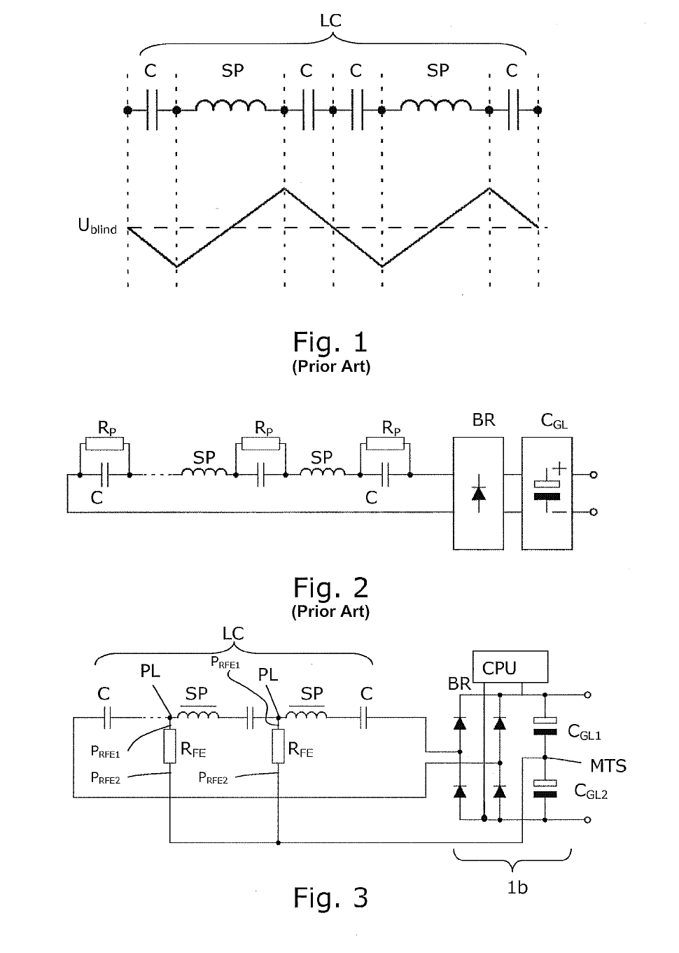

Capacitors must be either series-connected or parallel-connected to the coils of the contactless energy transmission system for power factor connection. FIG. 1 shows the series compensation circuit and the corresponding local reactive voltage distribution along the series resonant circuit.

In a parallel circuit, insulation monitoring is provided due to the fact that coils are already connected to the intermediate circuit or to the rectifier outlet by diodes. The aforementioned intermediate circuit is monitored by an insulation monitoring device which measures the resistance between the coils and the earth connection of the secondary device of the parallel resonant circuit on the secondary winding side, of which there is at least one, and compares it with stored data. If the measured resistance value deviates from the stored data by more than one absolute value, this is identified as an insulation fault and is reported to a higher-level control system.

In series compensation, the windings of the coils are galvanically isolated from the rest of the power electronics system by capacitors, meaning that insulation monitoring can no longer be achieved by means of a resistance measurement.

FIG. 2 shows a circuit wherein resistors Rₚ are parallel-connected to the capacitors C and can, in principle, be Intended for discharge in case of a fault in accordance with ECE R 100. The largest possible resistance value should be chosen for these resistors Rₚ, however, so that no unnecessary losses arise. As a result of the high-resistance resistors Rₚ, however, insulation tests are less reliable since the resistance value of the resistors Rₚ, which are ultimately provided as discharge resistors, is in the range of the insulation resistance of the windings, meaning that no great change in resistance can be measured even in the event of an insulation rupture.

The object of the invention is to facilitate simple insulation monitoring when using series resonant circuits.

This object is achieved in an advantageous way by means of the features of Claim 1. Advantageous further developments of the device according to Claim 1 emerge from the features of the subordinate claims.

The fault detection resistors cancel the galvanic isolation caused by the capacitors of the series resonant circuits so that, should an insulation fault occur in a coil, a fault current can flow through one or more fault detection resistors. In this case, the fault current flows from a control device, which can he an insulation monitoring device, through the single connecting line towards a fault detection resistor via at least one coil and thus reaches the insulation rupture, draining from there to a ground connection of the primary or secondary winding side of the device. Due to the measured fault current or to the dropping voltage(s) at one or a number of resistors, in particular the fault detection resistors, an insulation rupture can be identified. If the fault current is very low, this suggests that the insulation is still intact.

One advantage of this is that the fault current does not flow through a diode of the downstream rectifier.

Moreover, there is at least one fault detection resistor which connects the control device to a pole or centre-tapped pole of a coil.

If the insulation monitoring takes place at the primary side of the energy transmission system, the fault detection resistors are inserted between a ground connection of the upstream circuit on the primary winding side and a pole or centre tap of the respective cost.

If the fault detection resistor is connected by one of its poles to the central point or centre tap of a voltage divider of the downstream circuit, it is useful to connect the other pole of the fault detection resistor to the centre tap pole of the respective coil so that when the energy transmission system is operating normally, no current flows through the fault recognition resistor and therefore no losses occur.

As a rule, the downstream circuit is an intermediate voltage circuit which features a bridge rectifier and downstream smoothing capacitors. The smoothing capacitors form the voltage divider, wherein the connection point of the evenly sized smoothing capacitors forms the centre tap of the voltage divider.

It is possible that not every coil is assigned a fault detection resistor. Bridging resistors are parallel-connected to the adjacent capacitors so that the above-mentioned coil or coils are not galvanically isolated from the control device.

The control device measures either constantly or at intervals the resistance value, the fault current or the dropping voltage at a shunt resistor in the shared connecting line or at the fault detection resistors, whereby an error signal is emitted if a certain resistance value is exceeded or if the measured voltage values are exceeded.

If the fault recognition resistor, of which there is at least one, leads to losses when the energy transmission device is running, one advantage is that the fault recognition resistors can be made inoperable or decoupled from the series resonant circuits by means of at least one switching device so that no current flows through the fault recognition resistors during standard operation. To determine an insulation fault, the switching device, of which there is at least one. can be closed and the measurements to check an insulation fault can be carried out by the control device.

In order for the system to be able to identify the coil in which the insulation fault occurred, the fault recognition resistors can have different resistance values in order to identify the faulty coil, so that the faulty coil can be identified by reference to the size of the current or the measured voltage.

The contactless energy transmission system can be a single-phase or polyphase system. If it is a polyphase system, the respective coils of the single phases must each be assigned fault recognition resistors and/or bridging resistors must be parallel-connected to the capacitors arranged adjacent to the coils.

Insulation monitoring can be arranged either on the primary winding side or on the secondary winding side. It is, however, also possible to equip both the primary winding and the secondary side with an insulation monitoring system according to the invention.

In the following, different embodiments of the invention are explained in more detail with the aid of drawings.

They show:

FIG. 1: series compensation of a series resonant circuit of a secondary contactless energy transmission device together with the corresponding local reactive voltage distribution;

FIG. 2: series-compensated pick-up device with resistors parallel-connected to the capacitors for discharging the capacitors in the event of a fault or accident;

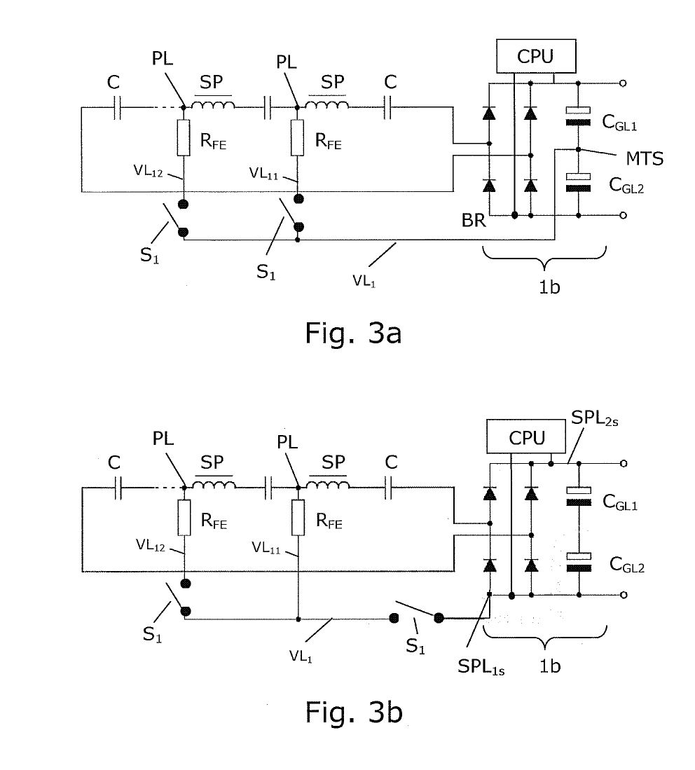

FIG. 3: series-compensated secondary pick-up device according to the invention with one fault recognition resistor per series resonant circuit coil, wherein the fault recognition resistors are each connected to a side contact of each coil;

FIG. 3a: circuit according to FIG. 3 with switches in the connecting lines for decoupling the fault recognition resistors;

FIG. 3b: alternative switch configuration for switching according to FIG. 3a;

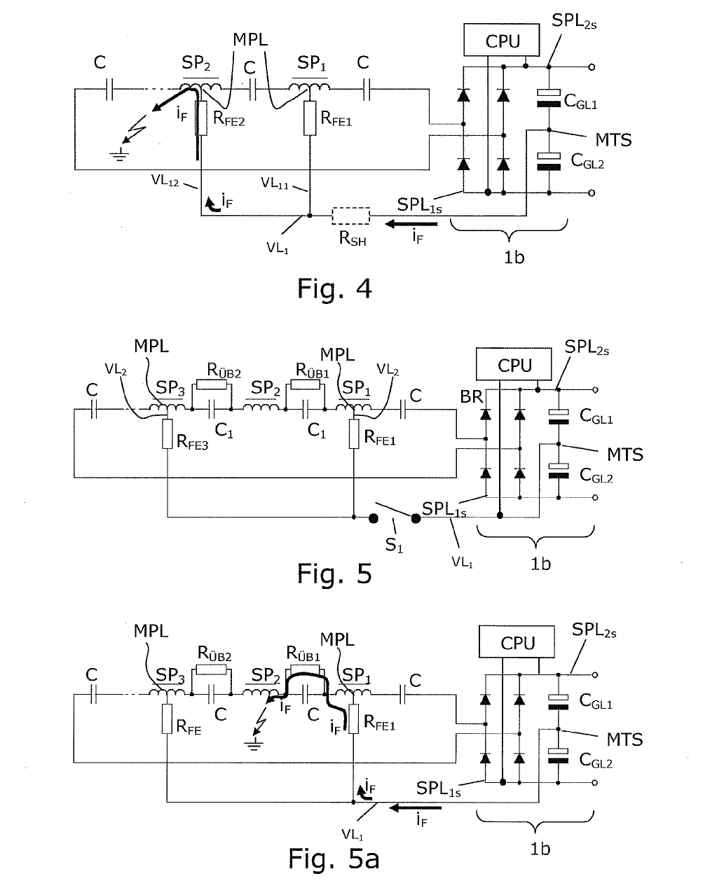

FIG. 4: a further possible embodiment of a secondary pick-up device, wherein the fault recognition resistors are attached to the centre tapped pole of each coil;

FIG. 5: a further possible embodiment of a secondary pick-up device, wherein no fault recognition resistor is assigned to the intermediate coil and therefore bridging resistors are parallel-connected to the capacitors adjacent to the coil:

FIG. 5a: depiction of the path of the fault current in the event of an insulation fault in the intermediate coil;

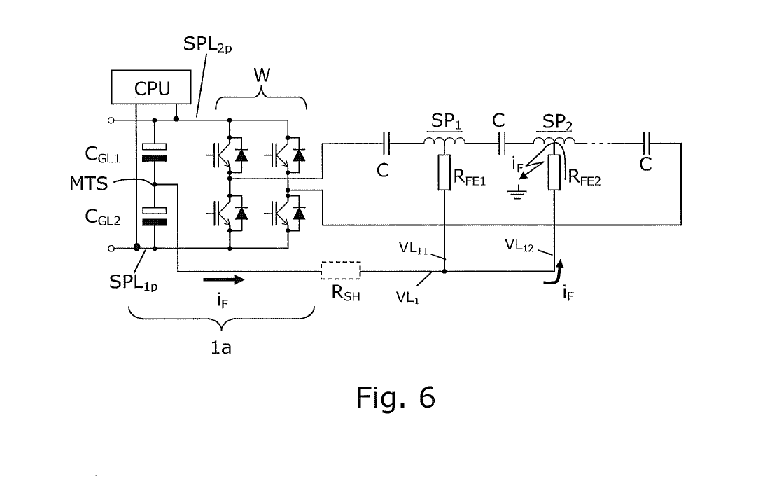

FIG. 6: preferred circuit for a device on the primary winding side.

FIG. 1 shows a series compensation of a series resonant circuit of a secondary contactless energy transmission device and the corresponding local reactive voltage distribution according to the state of the art. The series resonant circuit consists of the coils SP and the capacitors C. The reactive voltage is largest in amount at the connection points between the capacitors C and the coils SP. In contrast, the reactive voltage in the centre of the coil is always equal to zero.

FIG. 2 shows a series-compensated pick-up device with resistors Rₚ which are parallel-connected to the capacitors C and function as a means to discharge the capacitors C in the event of a fault or accident, as required by Regulation ECE R 100. As already stated, since the parallel resistors Rₚ must be highly resistive, it is difficult to identify an insulation fault.

In order for an insulation error to be detected with certainty, the invention proposes a first possible circuit configuration, as portrayed in FIG. 3. The galvanic isolation of the coils SP from the downstream circuit 1, which is formed as an intermediate voltage circuit composed of a bridge rectifier BR and smoothing capacitors C_{GL1} and C_{GL2}, is cancelled owing to the fault recognition resistors R_{FE}. The fault recognition resistors R_{FE} are connected to the output pole PL of the coils SP by their first poles P_{RFE1}. The fault recognition resistors R_{FE} are connected with their other first poles P_{RFE2} to the centre point or centre tap MTS of the voltage divider C_{GL1}, C_{GL2} of the downstream circuit 1. The control device CPU is connected by its terminals to the voltage potential poles SPL1 and SPL2 of the downstream circuit 1. Since the smoothing capacitors C_{GL1}, C_{GL2} of the downstream circuit 1 are so large in size, they do not present any significant resistance for the fault current i_{F} to be measured. in this circuit, however, there is a high voltage at the fault recognition resistors when the energy transmission device is operating normally, resulting in relatively large losses.

This can be corrected by the circuits according to FIGS. 3a and 3b, wherein switches S₁ are arranged in the connecting lines VL₁, VL₁₁ and VL₁₂. During standard operation of the energy transmission device the switches S₁ are open, meaning that no currents can flow through the fault recognition resistors R_{FE} and thereby ensuring that losses can be avoided during operation. In order to check the insulation, the switches can be closed while the device is in operation to check whether outbound fault current i_{F} is flowing from the control device CPU through the fault recognition resistors R_{FE}. The switches S₁ can, of course, be a relay, electric switches such as MOSFETs, etc.

FIG. 4 shows a preferred embodiment of the secondary device according to the invention, in which the fault recognition resistors R_{FE1} and R_{FE2} are connected with one of their poles to the centre-tapped pole MPL of the respective coils SP₁ and SP₂. Since, in theory, the average potential of the DC voltage intermediate circuit is reached at the

centre of the windings of the coils SP when under load, points MPL and MTS have the same level of potential, meaning that when the device is in operation, no current flows through the fault recognition resistors R_{FE1} and R_{FE2} and as a result no unwanted loses occur.

The circuit according to FIG. 3b differs from the circuit according to FIGS. 3 and 3a in that the connecting line VL₁ is connected to the voltage potential pole SPL₁ₛ of the intermediate circuit 1 rather than the point MTS.

As portrayed in FIG. 4, the coil SP₂ features an insulation fault. In this case, the fault current i_{F} flows from the control device CPU via the connecting lines VL₁ VL₁₂ and via the fault recognition resistor R_{FE2} and the coil SP₂ towards the ground connection SPL₁ₛ of the secondary device. By measuring the fault current i_{F} or the drop in voltage at the fault recognition resistor R_{FE2} or by means of a shunt resistor R_{SH} optionally arranged in the connecting line VL₁ and shown here with dotted lines, the insulation fault of the coil SP₂ can be identified with certainty.

It is, of course, possible to also include switch S₁ in the circuit according to FIG. 4, with the switch, which is open during standard operation, ensuring that no losses occur through the fault recognition resistors R_{FE1} and R_{FE2}.

It is, of course, not necessary to assign a fault recognition resistor R_{FE} to every coil SP. FIG. 5 shows a further possible circuit, wherein no fault recognition resistor R_{FE} is assigned to the intermediate coil SP₂. Since as a result of this, the coil SP₂ would usually be galvanically isolated from the control device CPU by the capacitors C adjacent to it, the invention allows for bridging resistors R_{ÜB}, which are parallel-connected to the capacitors C adjacent to the coil SP₂. When the switch S₁ is closed, the bridging resistors R_{ÜB} enable the fault current i_{F} (the thick arrow) to flow through the fault recognition resistor R_{FE1}, the coil SP₁ and the bridging resistor R_{ÜB1} towards the faulty coil SP₂, as illustrated in FIG. 5a, allowing the insulation fault in coil SP₂ to be identified with certainty.

FIG. 6 shows a preferred circuit for a device on the primary winding side according to the invention, an upstream circuit 1a, which, as illustrated, can be an inverter and features the series resonant circuit LC, wherein each fault recognition resistor R_{FE} is connected with its first pole P_{RFE1} to the centre-tapped pole MPL of the coil SP and connected with its other second pole P_{RFE2} to the centre tap MTS of a voltage divider which is formed by both capacitors C_{GL1} and C_{GL2} and which belongs to the upstream circuit 1a. The ports of the control device CPU. which performs an insulation monitor function, are connected to the two voltage potential poles SPL₁ₚ, SPL₂ₚ. The fault current iF flows as illustrated in FIG. 6, primarily via the connecting lines VL₁ and VL₁₂, the fault recognition resistor R_{FE2} and the coil SP₂ towards the ground potential of the device on the primary winding side 1a, if the coil insulation of the coil SP₂ is faulty. It is, of course, also possible that not every coil SP is assigned precisely one fault recognition resistor R_{FE} in the case of the device on the primary winding side. In such an embodiment, analogous to the circuits depicted in FIGS. 5 and 5a; the capacitors C adjacent to the coil to which no one fault recognition device R_{FE} is assigned would have to be bridged by a bridging resistor R_{ÜB} so that this coil is not galvanically isolated from the downstream circuit 1a.

1. A device for contactless energy transmission, the device including:
series resonant circuits on primary and secondary winding sides, wherein a respective series resonant circuit comprises at least one coil and at least two capacitors, wherein the series resonant circuit on the primary winding side is connected to an upstream circuit and the series resonant circuit on the secondary winding side is connected to a downstream circuit;
the device further including at least one of:
a fault recognition resistor connected by a first pole of the fault recognition resistor to a pole or to a centre-tapped pole of at least one coil of the series resonant circuit on the primary winding side, wherein a second pole of the fault recognition resistor is connected to a centre point or centre tap of a voltage divider or to a voltage potential pole of the upstream circuit; or
a fault recognition resistor connected by a first pole of the fault recognition resistor to a pole or to a centre-tapped pole of at least one coil of the series resonant circuit on the secondary winding side, wherein a second pole of the fault recognition resistor is connected to a centre point or centre tap of a voltage divider of the downstream circuit or to a voltage potential pole of the downstream circuit.

2. The device according to claim 1, wherein that the upstream circuit, the downstream circuit, or each of the upstream and downstream circuits is an intermediate voltage circuit.

3. The device according to claim 2, wherein at least one of the following is true:
the upstream circuit comprises an inverter; or
the intermediate voltage circuit of the downstream circuit comprises bridge rectifier and one or more downstream smoothing capacitors.

4. The device according to claim 1, further including a bridge resistor that is parallel-connected to one or more capacitors adjacent to a coil with no fault recognition resistor is attached to its pole or centre-tapped poles.

5. The device according to claim 1, further including a control device configured to measure at least one resistance value between two voltage potential poles either constantly or at intervals and to emit an error signal if the at least one measured resistance value exceeds a certain resistance value.

6. The device according to claim 5, wherein the control device is configured to emit a signal if the at least one measured resistance value is below a stored value.

7. The device according to claim 1, further including a control device configured to measure a control device, either constantly or at intervals, current flowing through one or more connecting lines and/or either currents flowing through the individual fault recognition resistor or resistors or dropping voltages at the fault recognition resistor or resistors and configured to emit emits an error signal if a deviation from one or more stored values is identified.

8. The device according to claim 7, wherein the control device is configured to apply a voltage potential to the one or more connecting lines so that in the event of an insulation fault, fault current flows through the one or more connecting lines.

9. The device according to claim 5, wherein the control device includes one port connected to one voltage potential pole and another port to another voltage potential pole of the upstream circuit or the downstream circuit.

10. The device according to claim 1, further including a switching device arranged in a connecting line, of which there is at least one, and which is configured to connect either one, several or all of the fault recognition resistor(s) to the centre point or centre tap of the voltage divider or to the voltage potential pole.

11. The device according claim 1, further including a switching device arranged in at least one connecting line that connects a fault recognition resistor to a pole or centre-tapped pole of a coil.

12. The device according to claim 1, further including a control device and one or more switching devices, wherein the control device is configured to control the one or more switching devices in such a way that it closes the one or more switching devices to measure at least one resistance value and opens the one or more switching devices for standard energy transmission.

13. The device according to claim 1, wherein the device includes multiple fault recognition resistors, and wherein the fault recognition resistors feature different resistance values in order to identify a faulty coil.

14. The device according to claim 1, wherein the contactless energy transmission system is a single-phase or polyphase system.

15. The device according to claim 1, further including a respective control devices arranged on both the primary winding side and the secondary winding side for the purpose of insulation monitoring.

16. The device according to claim 5, wherein the control device comprises an insulation monitoring device.

17. The device according to claim 7, wherein the control device comprises an insulation monitoring device.
